(19) United States
(12) Patent Application Publication
(10) Pub. No.: US 2022/0092486 A1
(43) Pub. Date: Mar. 24, 2022

(54) SYSTEM AND METHOD OF SMART SEATING MANAGEMENT

(71) Applicant: Rooda Omran AL-QEBAISI, Ar-Rayyan, Doha (QA)

(72) Inventor: Rooda Omran AL-QEBAISI, Ar-Rayyan, Doha (QA)

(21) Appl. No.: 17/421,494

(22) PCT Filed: Jan. 9, 2019
(86) PCT No.: PCT/QA19/50001

§ 371 Date: Jul. 8, 2021

(51) Int. Cl. G06Q 10/02; G06Q 10/06; A47C 31/00; A47C 1/12; H04N 5/33; G06K 7/14

(52) U.S. Cl. CPC G06Q 10/02; G06Q 10/0639; G06K 7/1417; A47C 1/12; H04N 5/33; A47C 31/008

(57) ABSTRACT

A seating management system having a plurality of chairs, each chair having a code scanner, an object detection sensor, a motor, and a communication device in operative communication with a central management server. The central management server is configured to pre-assign a reservation code for each of the chairs, assign each of the invited guests to a chair, cause an invitation to be sent to each of said invited guests, and analyze the invited guest responses. The server is then configured to activate the plurality of chairs, send the corresponding reservation code to each guest whose response accepted the invitation, and cause the motor of the respective activated chair to move said chair when the central management server receives a reservation code corresponding to said chair.

### BACKGROUND

Organizers of large-scale events with many guests must balance numerous, ever-changing details. Such details include the guest list and the accompanying seating arrangement, which can present a host of problems. Event organizers must track whether guests have indicated they plan to attend, and if done manually, this task takes time and is prone to error as the guest list may change frequently. Guests may attempt to sit in seats not assigned to them, or that they did not pay for, which can create conflict that pulls an organizer's attention away from his or her other duties on the event day. It also may be difficult for guests to get assistance during the event while the organizer and his or her staff are dealing with other issues. And for events that require more security, it is important that event organizers know who is on the guest list and that only those people are allowed into the event. Additionally, businesses and other organizations have varying demands when it comes to hosting events and desire customizability to adhere to certain event set-up desires, security concerns, or financial constraints, among other issues. One solution to such issues is a smart seating system that utilizes the internet of things and can be customized to meet consumer demands.

### SUMMARY

To improve the efficiency of event organization and the comfort of event attendance, a new smart seating management system is provided herein. To utilize the system, a new seating management method and smart chair are disclosed. More specifically, a smart chair, central management server, soft application, and web portal are all in operative communication with one another to allow an event organizer to seamlessly organize an event and an event guest to comfortably attend an event.

In light of the disclosure herein, and without limiting the scope of the invention in any way, in a first aspect of the present disclosure, which may be combined with any other aspect listed herein unless specified otherwise, a seating management system includes a plurality of chairs. The chairs each include a code scanner, an object detection sensor, a motor, and a communication device in operative communication with a central management server. The central management server is configured to pre-assign a reservation code for each of the chairs, assign each of the invited guests to a chair, cause an invitation to be sent to each of said invited guests, and analyze the invited guest responses. If one of the invited guests declines or delegates the invitation to a different guest, the server sets a new reservation code for the respective chair originally assigned to the invited guest. If one of the invited guests accepts the invitation, the server maintains the reservation code of the chair originally assigned to the invited guest. The server is then configured to activate the plurality of chairs, send the corresponding reservation code to each guest whose response accepted the invitation, and cause the motor of a chair to move the chair when the central management server receives a reservation code corresponding to that chair.

In a second aspect of the present disclosure, which may be combined with any other aspect listed herein unless specified otherwise, the central management server is further configured to generate a performance analysis report.

In a third aspect of the present disclosure, which may be combined with any other aspect listed herein unless specified otherwise, the reservation codes are pre-assigned to each of the plurality of chairs on the basis of a designated seating template.

In a fourth aspect of the present disclosure, which may be combined with any other aspect listed herein unless specified otherwise, the central management server causes the motor to rotate the chair to a predesignated viewing position for the event.

In a fifth aspect of the present disclosure, which may be combined with any other aspect listed herein unless specified otherwise, the central management server will not cause the motor to rotate the chair if an object detection sensor detects an object in the chair.

In a sixth aspect of the present disclosure, which may be combined with any other aspect listed herein unless specified otherwise, the object detection sensor in the seating management system is an infrared sensor.

In a seventh aspect of the present disclosure, which may be combined with any other aspect listed herein unless specified otherwise, the reservation code used in the seating management system is a QR code.

In an eighth aspect of the present disclosure, which may be combined with any other aspect listed herein unless specified otherwise, a method for managing event seating arrangements includes receiving an input selecting from a variety of seating arrangements. Each seating arrangement includes a plurality of chairs, and each of the chairs in each seating arrangement has a pre-assigned reservation code. The method then includes receiving inputs assigning invited guests to the chairs in the selected seating arrangement, sending invitations to those invited guests, and receiving responses to the invitations. If a response from the invited guest declines or delegates the invitation, a new reservation code is set for that guest's chair. If an invited guest delegates the invitation, the information assigned to the guest's chair is changed to the delegated guest's information. The method then includes activating the chairs in the seating arrangement and sending each guest that accepted an invitation the reservation code corresponding to his or her chair. The method then includes sending a signal to the chair's motor to move the chair if a central management server receives a reservation code corresponding to the chair.

In a ninth aspect of the present disclosure, which may be combined with any other aspect listed herein unless specified otherwise, the method includes generating a performance analysis report.

In a tenth aspect of the present disclosure, which may be combined with any other aspect listed herein unless specified otherwise, the method includes receiving a request from a guest and alerting an organizer.

In an eleventh aspect of the present disclosure, which may be combined with any other aspect listed herein unless specified otherwise, the reservation code used in the method is a QR code, a mobile application signal, or a master key signal.

In a twelfth aspect of the present disclosure, which may be combined with any other aspect listed herein unless specified otherwise, the method includes the motor rotating the chair to a predesignated viewing position for the event.

In a thirteenth aspect of the present disclosure, which may be combined with any other aspect listed herein unless specified otherwise, the method includes the motor not rotating the chair if an object detection sensor detects that an object is in the chair. The object detection sensor is attached or built into the chair.

In a fourteenth aspect of the present disclosure, which may be combined with any other aspect listed herein unless specified otherwise, the method includes using an object detection sensor that is an infrared sensor.

In a fifteenth aspect of the present disclosure, which may be combined with any other aspect listed herein unless specified otherwise, a smart chair capable of communicating with a network includes a smart display, a code scanner, a communication device, an object detection sensor, and a motor. The smart display is attached or built into the back of the chair. The communication device is in operative communication with a central management server. The object detection sensor is configured to detect whether an object is in the chair. The motor is configured to move the chair.

In a sixteenth aspect of the present disclosure, which may be combined with any other aspect listed herein unless specified otherwise, the smart chair's motor is configured to rotate the chair to a predesignated viewing position for the event.

In a seventeenth aspect of the present disclosure, which may be combined with any other aspect listed herein unless specified otherwise, the smart chair's motor will not rotate the chair if the object detection sensor detects an object in the chair.

In an eighteenth aspect of the present disclosure, which may be combined with any other aspect listed herein unless specified otherwise, the smart chair's object detection sensor is an infrared sensor.

In a nineteenth aspect of the present disclosure, which may be combined with any other aspect listed herein unless specified otherwise, the smart chair's code scanner is configured to recognize QR codes.

In a nineteenth aspect of the present disclosure, which may be combined with any other aspect listed herein unless specified otherwise, the smart chair includes a service button for requesting assistance.

### BRIEF DESCRIPTION OF THE FIGURES

FIG. 1 illustrates a system according to an exemplary embodiment of the present disclosure.

FIG. 2 illustrates an exemplary embodiment of a user interface for a web portal.

FIG. 3 illustrates a system according to an exemplary embodiment of the present disclosure.

FIG. 4 illustrates an exemplary embodiment of a user interface for an application.

FIG. 5 illustrates a system according to an exemplary embodiment of the present disclosure.

FIG. 6 illustrates an example seating arrangement for a concert.

FIG. 7 illustrates an example seating arrangement for performances.

FIG. 8 illustrates an example seating arrangement for sporting events.

FIG. 9 illustrates an example seating arrangement for dinners and galas.

FIG. 10 illustrates an example seating arrangement for expos.

FIG. 11 illustrates an example seating arrangement for a theater.

FIG. 12 illustrates an example seating arrangement for a classroom.

FIG. 13 illustrates an example herringbone seating arrangement.

FIG. 14 illustrates an example U-shape seating arrangement.

FIG. 15 illustrates an example horseshoe seating arrangement.

FIG. 16 illustrates an example hollow square seating arrangement.

FIG. 17 illustrates an example seating arrangement for a boardroom.

FIG. 18 illustrates an example seating arrangement for a banquet.

FIG. 19 illustrates an example seating arrangement for a cabaret.

FIG. 20 illustrates an example seating arrangement for an event with guest tables and no stage.

FIG. 21 illustrates an example seating arrangement for an event with guest tables and a stage.

FIG. 22 illustrates an example seating arrangement for an event with a banquet table and guest tables.

FIG. 23 illustrates an example seating arrangement for an event with a banquet table.

FIG. 24 illustrates an example seating arrangement for a typical mess dinner.

FIG. 25 illustrates an example seating arrangement for a naval mess dinner.

FIG. 26 illustrates an example seating arrangement for an event without acoustics or performance art.

FIG. 27 illustrates an example seating arrangement for an event with performance art.

FIG. 28 illustrates an example seating arrangement for an event with seating on a stage.

FIG. 29 illustrates exemplary embodiments of chairs in the open and closed positions with regards to a stage.

FIG. 30 illustrates a method according to an exemplary embodiment of the present disclosure.

FIG. 31 illustrates a method according to an exemplary embodiment of the present disclosure.

FIG. 32 illustrates a method according to an exemplary embodiment of the present disclosure.

FIG. 33 illustrates a smart chair according to an exemplary embodiment of the present disclosure.

FIG. 34 illustrates an exploded view of a display used with a smart chair according to an exemplary embodiment of the present disclosure.

FIG. 35 illustrates a smart chair connected to a motor according to an exemplary embodiment of the present disclosure.

FIG. 36 illustrates an exploded view of a service button with an IR sensor built into its housing according to an exemplary embodiment of the present disclosure.

FIG. 37 illustrates a power system for a smart chair according to an exemplary embodiment of the present disclosure.

### DETAILED DESCRIPTION

The system and method of smart seating management described herein are utilized by multiple different parties during one instance of use and are worth mentioning from the start. Throughout this disclosure, an event organizer is a central party working with a venue, an event holder, and event guests to coordinate the event and may be any person, company, or organization that is utilizing the seating management system 100. The event management team are those people who work for the event organizer. The venue is the location where the event is being held. The event holder is the party who hired the event organizer and is having the event. The event guests are any persons who are attending the event at which the seating management system 100 is being used.

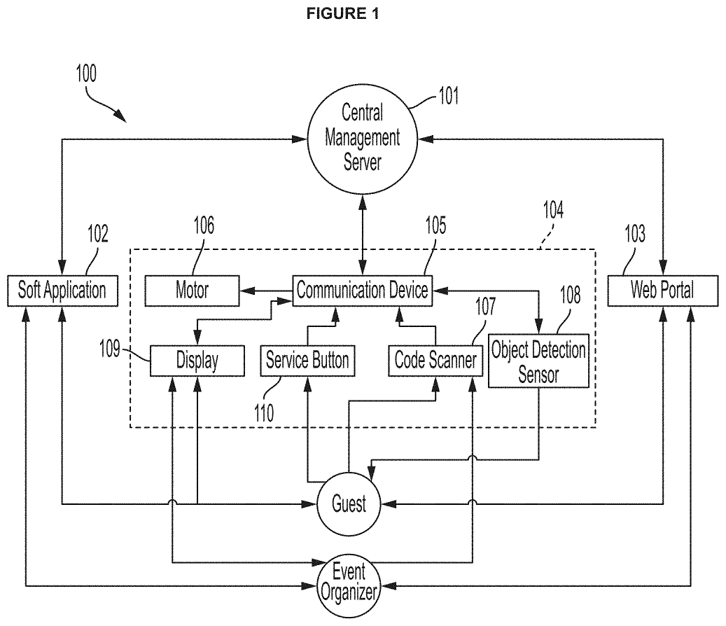

Referring now to the drawings and in particular to FIG. 1, a seating management system 100 comprises a plurality of smart chairs 104, a soft application 102, a web portal 103, and a central management server 101. The central management server 101 is in general the nexus or hub that allows communication between all of the system components. In various embodiments, the central management server 101 includes one or more services storing software executable to perform the claimed method disclosed herein. The executable software may be stored on a local server, on multiple devices such as a mobile device, tablet, laptop, desktop computer, or wearable device, or portions of the software could be split among any of the above. In various embodiments, portions of the software are stored on the device which houses the soft application 102. The software may also be a web-based application and may be executed in the cloud.

When organizing an event using the seating management system 100, an event organizer must choose a seating arrangement, input guest information, update guest information, assist guests, open chairs, and perform other functions. In doing so, an event organizer must communicate with the central management server 101. An event organizer can communicate with the server 101 in one of three ways. First, the event organizer may communicate with the server 101 through the web portal 103, such as by using a website on an internet browser. Second, the event organizer may use a device which runs the soft application 102. Or, third, the event organizer may use the display 109 of a smart chair 104 or scan a code with code scanner 107 of a smart chair 104. In various embodiments, the soft application 102 is a smart phone application run on a smart phone. It should be appreciated that in various other embodiments, the soft application 102 may be an application on a tablet, wearable device, or any other electronic device.

A guest of an event must also use the seating management system 100. A guest may accept, decline, or delegate an invitation to an event, buy tickets to an event, open his or her chair at the event, or request assistance at the event. Therefore, a guest must also communicate with the central management server 101. A guest can communicate with the server 101 in the same three ways as an event organizer. In various embodiments, a guest may also use the service button 110 of his or her smart chair 104 to request assistance from the event organizer through the soft application 102.

In response to event organizer and guest communications with the central management server 101, the server 101 communicates with event organizers, guests, and each smart chair 104. The central management server 101 communicates with event organizers and guests through the soft application 102, the web portal 103, or a display 109 of a smart chair 104. The server 101 communicates with a smart chair 104 through the communication device 105 of each chair.

The communication between the central management server 101 and the soft application 102, between the server 101 and the communication device 105 of each chair 104, and between the server 101 and the web portal 103 can be wireless as part of the internet of things or may be a wired communication, such as Ethernet. It should be appreciated that in various other embodiments any wired communication technology may be used. Wireless communication may, for example, be via Bluetooth TM or WiFiTM wireless communication technology. It should be appreciated that in various other embodiments any wireless communication technology may be used.

In one embodiment, each smart chair 104 of the system 100 comprises a communication device 105, a motor 106, a code scanner 107, an object detection sensor 108, a display 109, and a service button 110. The communication device 105 enables each smart chair 104 and the central management server 101 to operatively communicate. For example, in one embodiment, when a guest scans a QR code on the code scanner 107 of his or her smart chair 104, the communication device 105 communicates the code to the central management server 101 which checks whether the scanned QR code matches the QR code assigned to the respective smart chair 104. If the QR codes match, the central management server 101 communicates such fact to the communication device 105 which then causes the motor 106 of the respective smart chair 104 to rotate the chair. In other various embodiments, the chairs will not rotate, but will move left, right, forward, back, up, or down. In a further example of various embodiments, if an event organizer attempts to unlock a smart chair 104 remotely using the soft application 102 for a guest on the day of the event, the central management server 101 will communicate the order to the communication device 105 which will ping the object detection sensor 108 of the respective smart chair 104. If the object detection sensor 108 detects an object in the chair, it will notify the communication device 105 which will send the message to the central management server 101. The central management server 101 will then send an error message on the soft application 102 to the event organizer notifying the organizer that the seat is occupied.

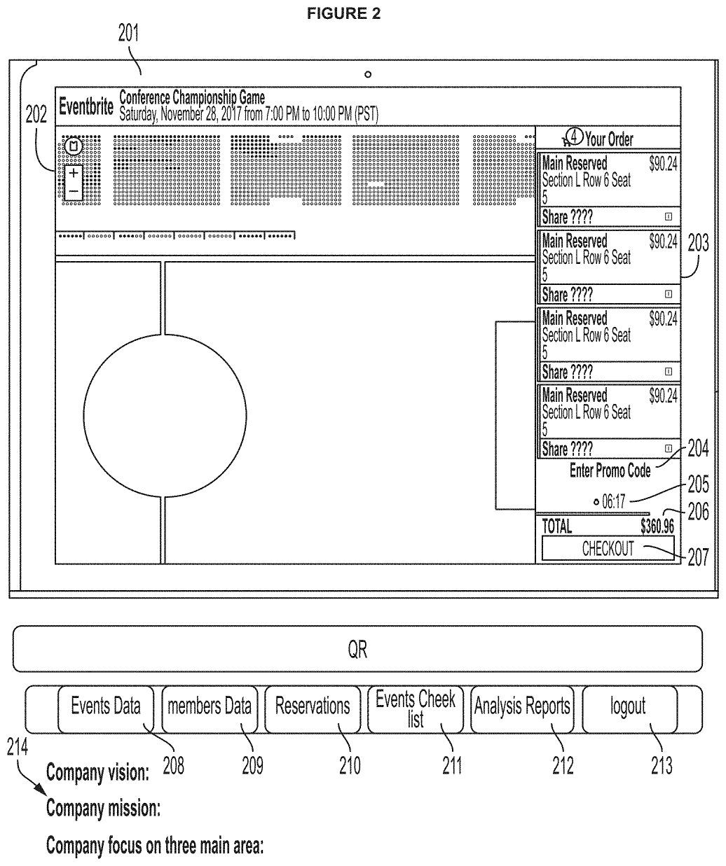

As stated, one user access point to the system 100 is the user interface of web portal 103. FIG. 2 illustrates an example embodiment of the user interface of web portal 103 for purchasing tickets to a Conference Championship Game using Eventbrite. At the top of the screen is the event information 201, including the event name, date, and time. Below that descriptive information are seating chart views 202 for the event indicating which seats are available for purchase and which have already been purchased. On the right-hand side of the user interface are detailed descriptions of each ticket available for purchase 203, including the exact seat location and price, a promo code box 204, a time remaining 205 to complete the ticket purchase, a total purchase price 206 for the tickets selected, and a checkout button 207. In various embodiments, the user interface of web portal 103 also includes a company news section 214 and links to other sections, including events data 208, members data 209, reservations 210, events check list 211, analysis reports 212, a logout button 213.

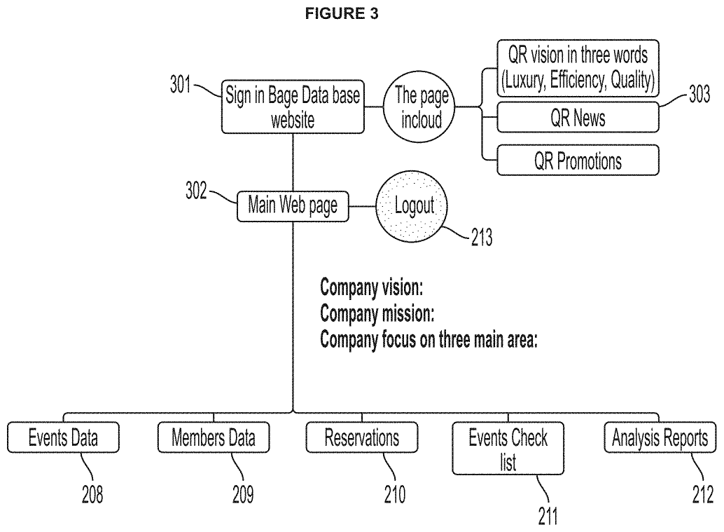

Now referring to FIG. 3, the web portal 103 in various embodiments includes a sign-in page 301, from which a user may navigate to the company news section 303 or to a main page 302. There are then numerous sections on the main page to which a user may navigate to view information in addition to the logout button 213. For example, in various embodiments the user interface comprises the events data section 208, the members data section 209, the reservations section 210, the events check list section 211, and the analysis reports section 212. Said sections contain information on events, customers, and event organizers, for example, an events calendar, a database of guest information, event details for guests, a location seating map, event logistical information for organizers, the status of all seats, event financial information, a user profile, after-event reports, and similar information.

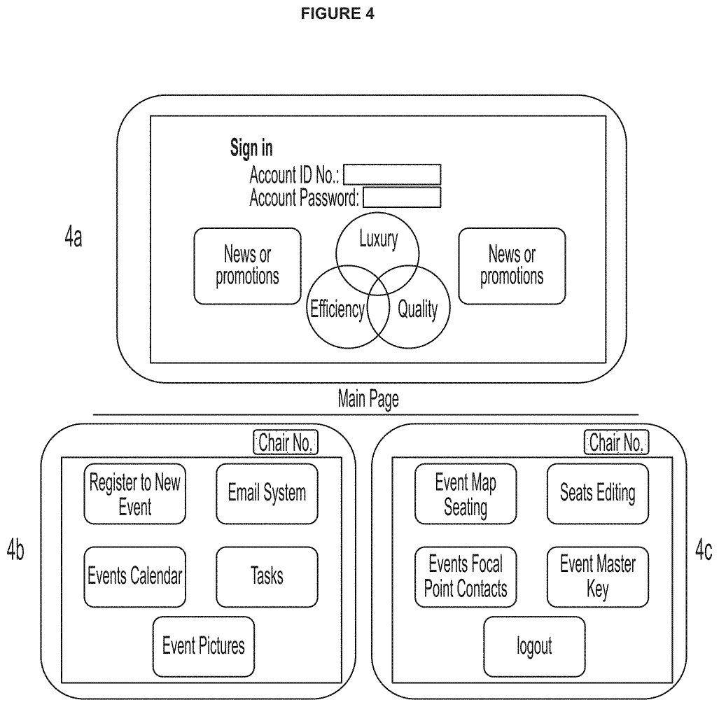

As stated, another user access point to the system 100 is the user interface of soft application 102. The soft application 102 may be executed on a variety of portable mediums, such as a mobile device, tablet, or wearable device. FIG. 4 illustrates one embodiment of the user interface of soft application 102. FIG. 4a illustrates an example sign-in screen. In one embodiment, the user interface at this screen is labeled “Sign in” at the top with boxes to enter an “Account ID No.” and an “Account Password.” In one embodiment, various news or promotions are visible on the screen surrounding a company logo. FIG. 4b illustrates an example main page. In one embodiment, the user interface on the main page includes links to register to a new event, an events calendar, an email system, tasks, and event pictures. FIG. 4c illustrates an example event page. In one embodiment, the user interface on the events page includes links to event map seating, event focal point contacts, a seats editing tool, an event master key, and a logout button.

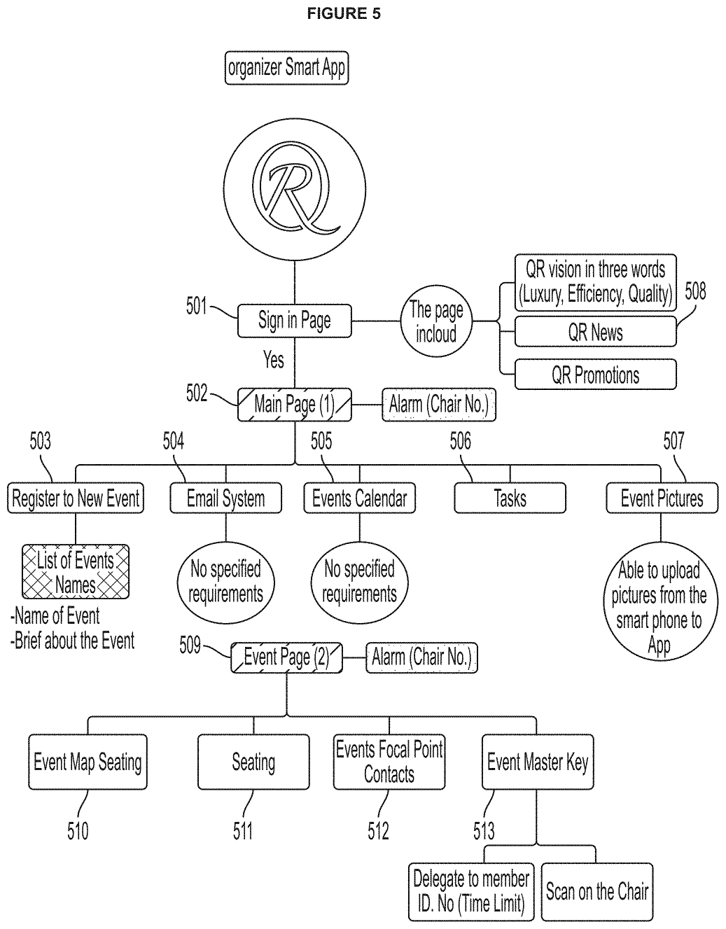

Now referring to FIG. 5, the soft application 102 in various embodiments includes a sign-in page 501, from which a user may navigate to a company news section 508, a main page 502, or an events page 509. There are then numerous sections on the main page 502 a user may navigate to, for example, in various embodiments the user interface of the main page 502 comprises a section to register for a new event 503, including information about the event, an email system 504, an events calendar 505, a tasks section 506, and an event pictures section 506 in which users can upload pictures from the event. There are also numerous sections on the event page 509 that a user may navigate to, for example, in various embodiments the user interface of the event page 509 comprises an event seating map 510, a seating section 511 in which guests can interact with the central management server 101 to open their assigned chairs, an event contact information section 512, and an event master key section 513 in which event organizers can interact with the central management server 101 to open chairs.

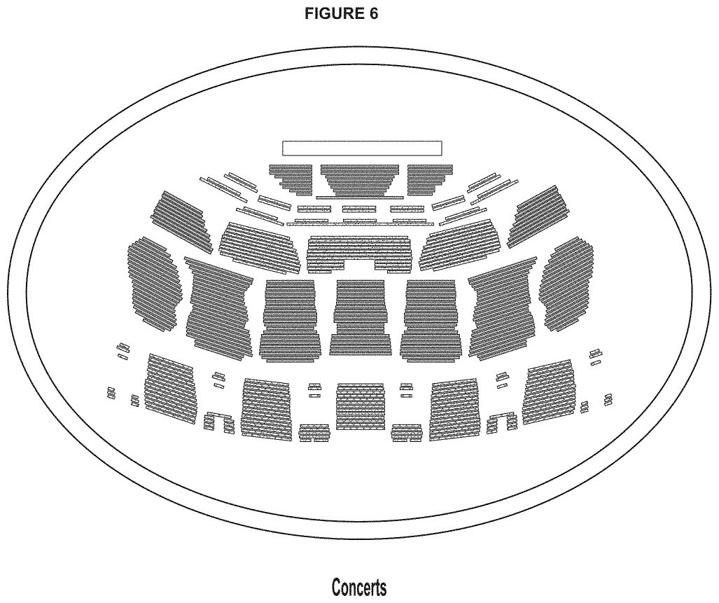

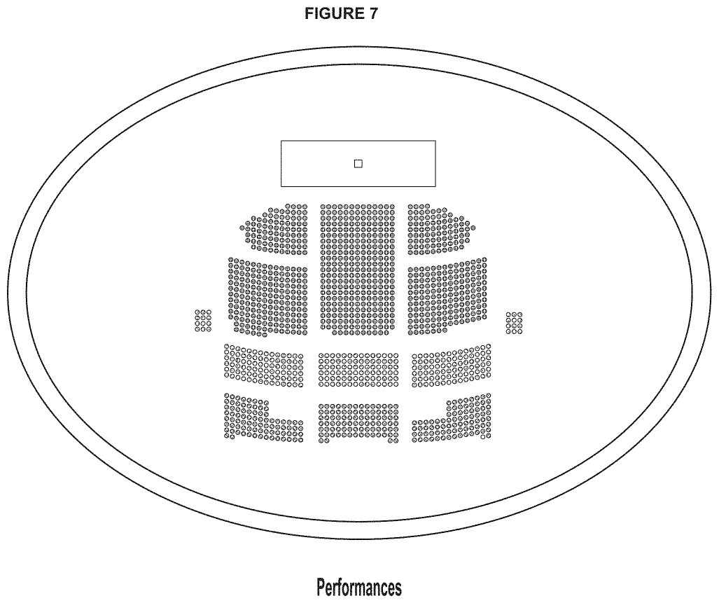

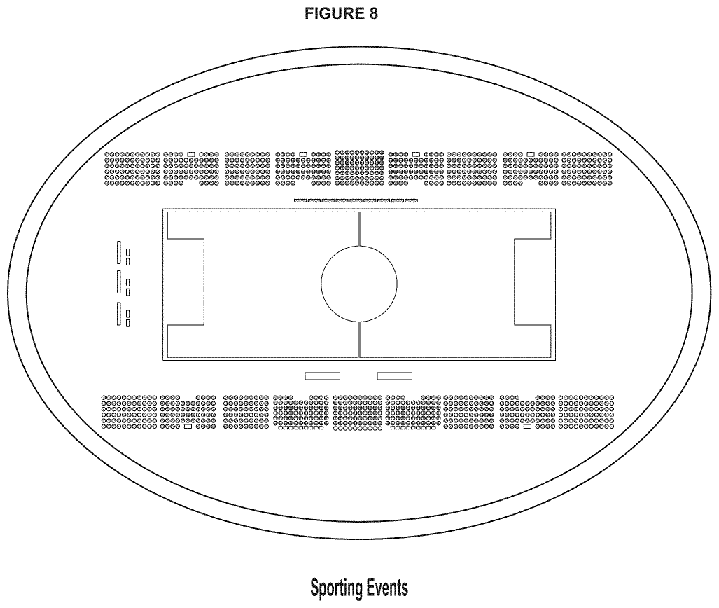

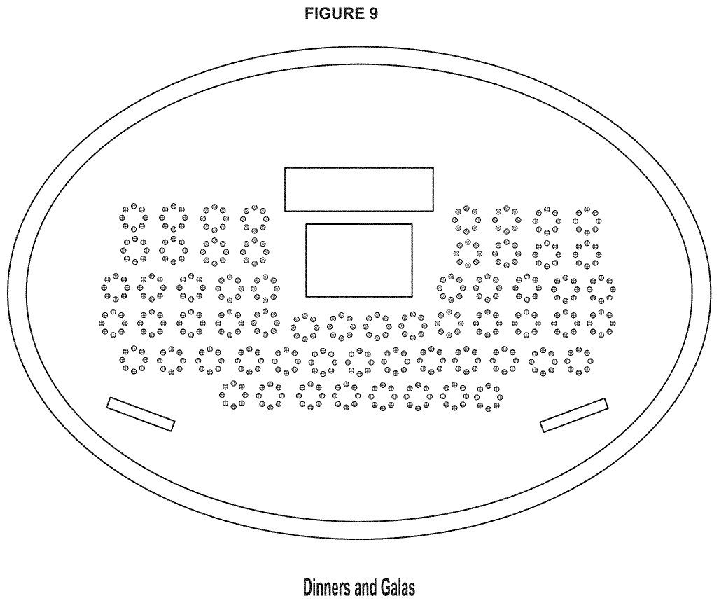

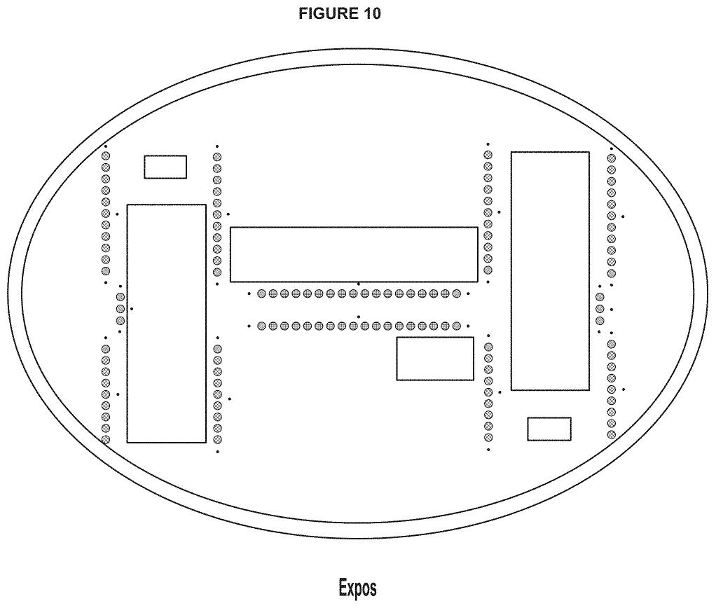

The seating management system 100 may be used with any seating arrangement and thus is customizable to a user's needs. FIGS. 6-10 illustrate example embodiments of general seating arrangements for big events. FIG. 6 illustrates an example concert seating arrangement. FIG. 7 illustrates an alternate example of a performance seating arrangement. FIG. 8 illustrates an example seating arrangement for a sporting event. FIG. 9 illustrates an example seating arrangement for dinners and galas. FIG. 10 illustrates an example seating arrangement for various expos.

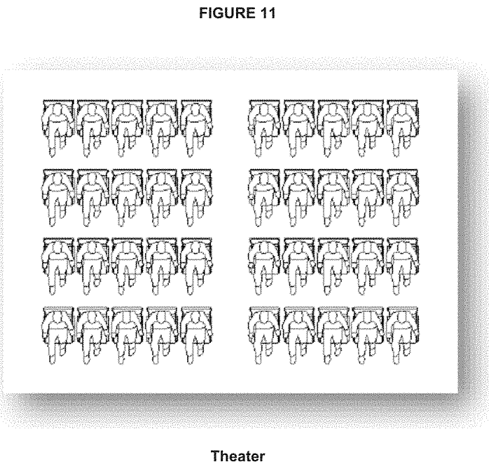

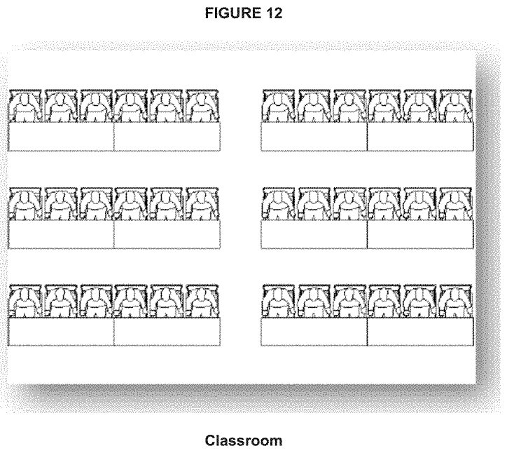

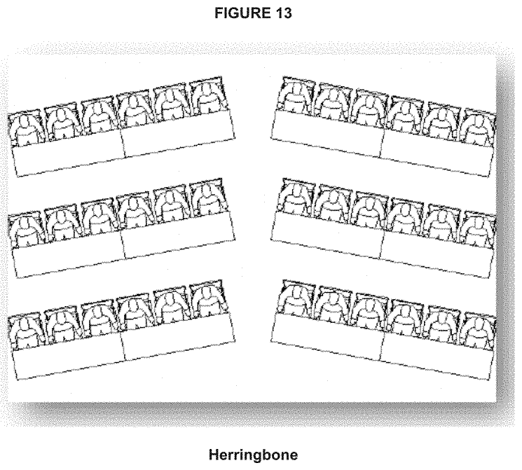

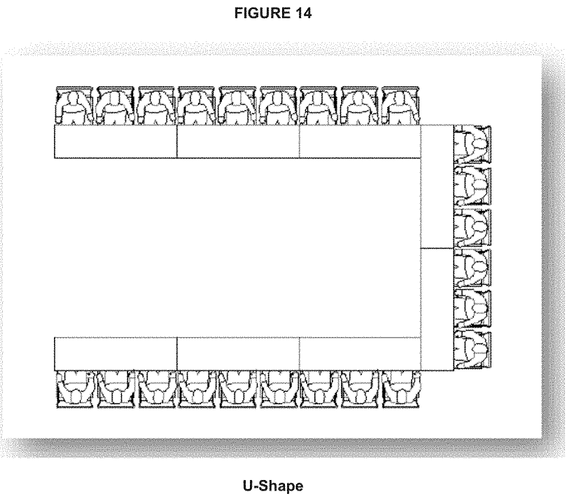

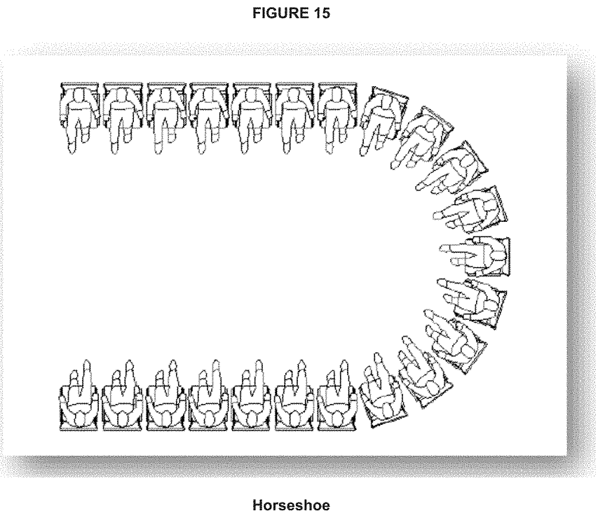

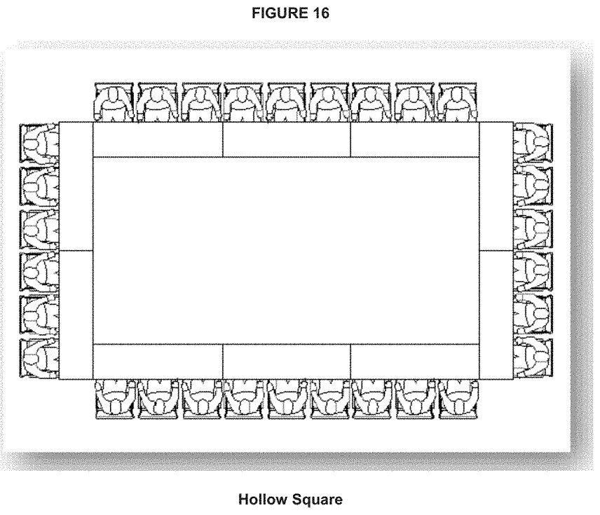

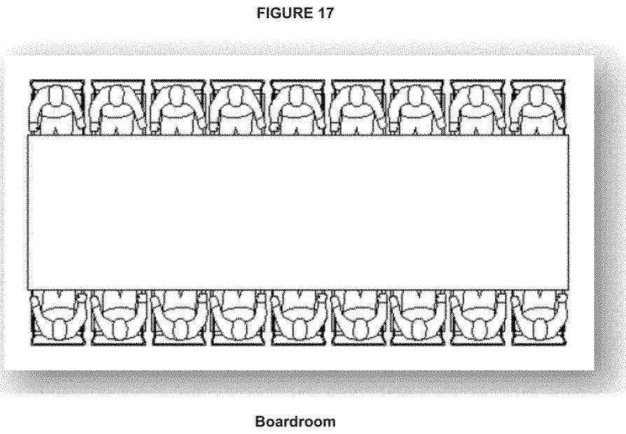

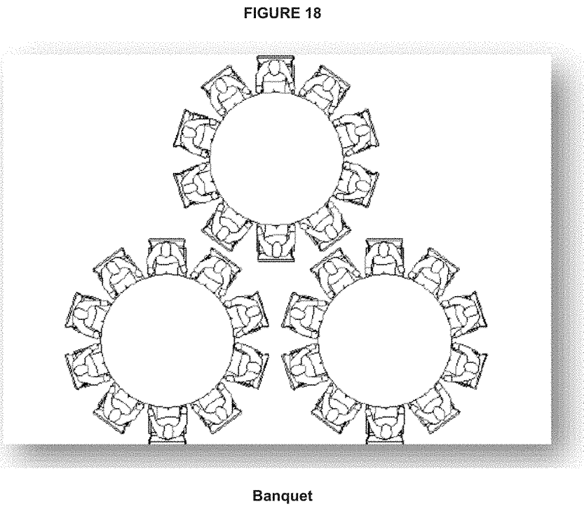

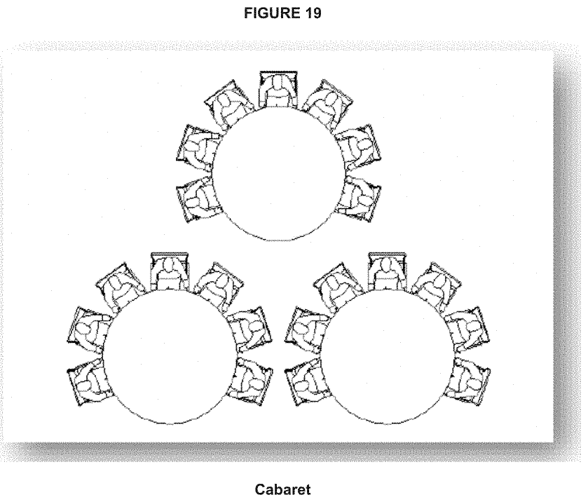

FIGS. 11-19 illustrate example embodiments of seating arrangements used for special events. FIG. 11 illustrates an example seating arrangement for a theater, which is popular for meetings and product launches. FIG. 12 illustrates an example seating arrangement for a classroom, which is popular for training, conferences, sales kick-offs, and product launches. FIG. 13 illustrates an example herringbone seating arrangement, which is popular for training, conferences, and lectures. FIG. 14 illustrates an example U-shape seating arrangement, which is popular for training, conferences, workshops, and meetings. FIG. 15 illustrates an example horseshoe seating arrangement, which is popular for large meetings, presentations, and team briefings. FIG. 16 illustrates an example hollow square seating arrangement, which is popular for discussions. FIG. 17 illustrates an example seating arrangement for a boardroom, which is popular for small meetings, one-on-one interviews, small presentations, and team briefings. FIG. 18 illustrates an example seating arrangement for a banquet, which is popular for gala dinners, awards nights, Christmas parties, weddings, and other informal events. FIG. 19 illustrates an example seating arrangement for a cabaret, which is popular with meetings such as training sessions, awards nights, and gala dinners. Other special events that the system 100 may be used for include cocktail parties and other social events. In one embodiment, the seating management system 100 is used in a lounge zone that is typically a private area divided into four parts: a smoking area, a quiet area, a business area, and a rest area with showers.

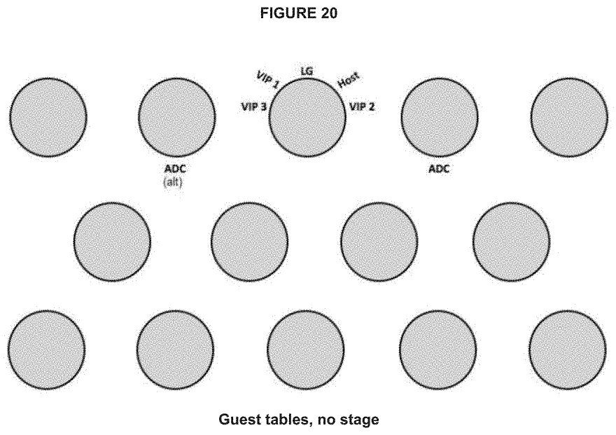

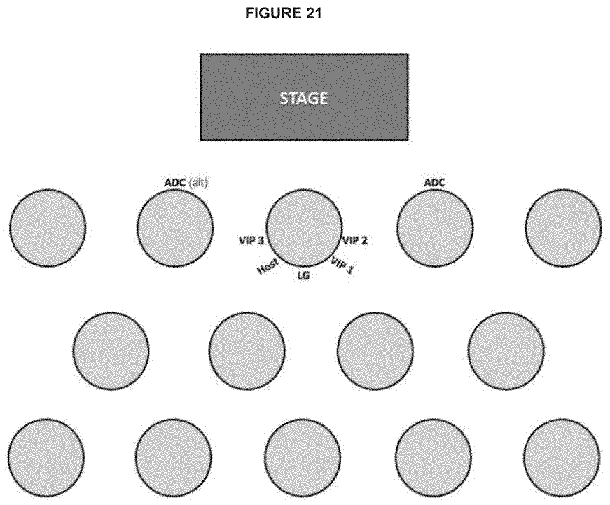

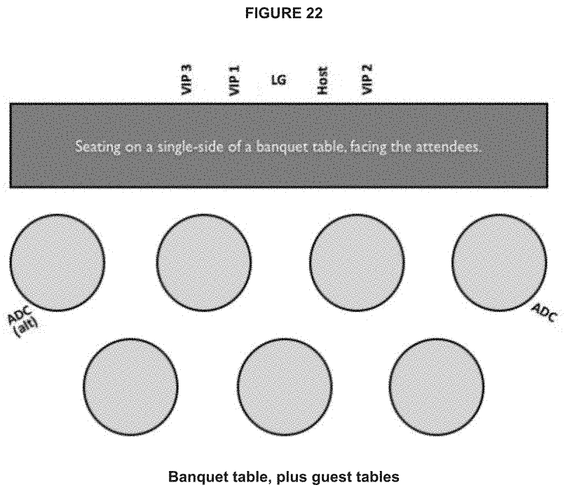

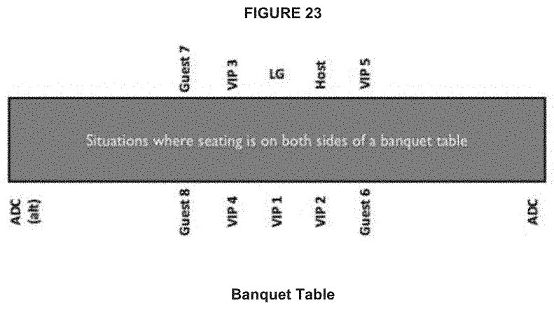

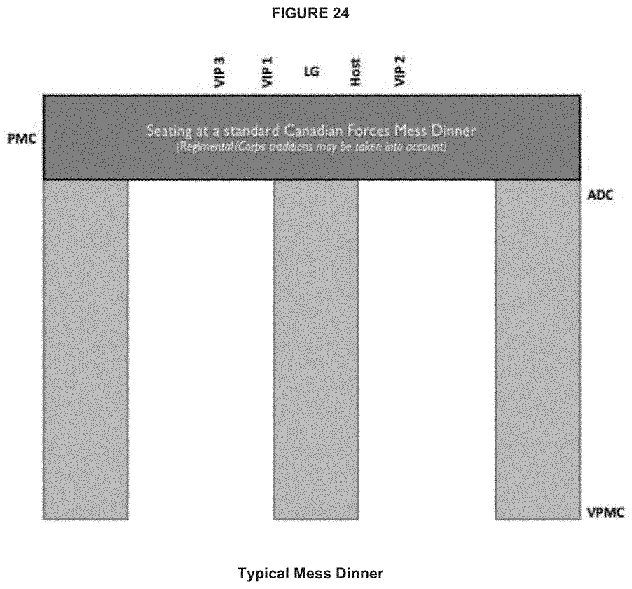

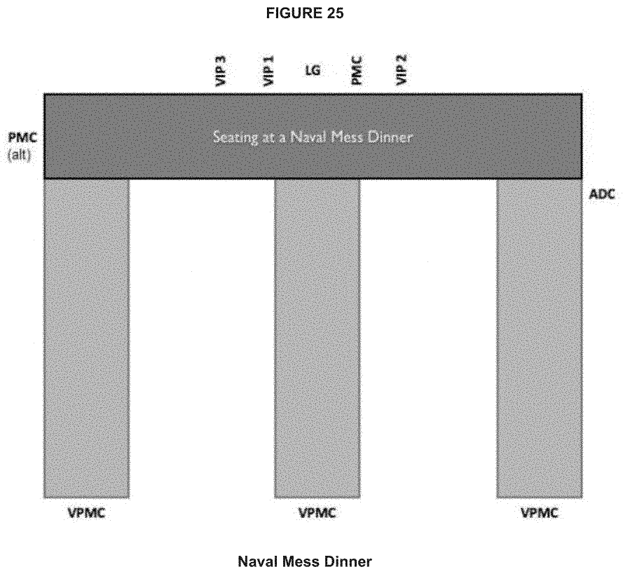

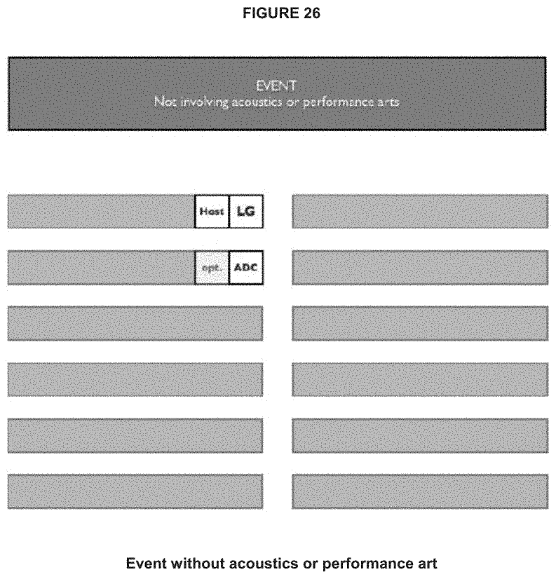

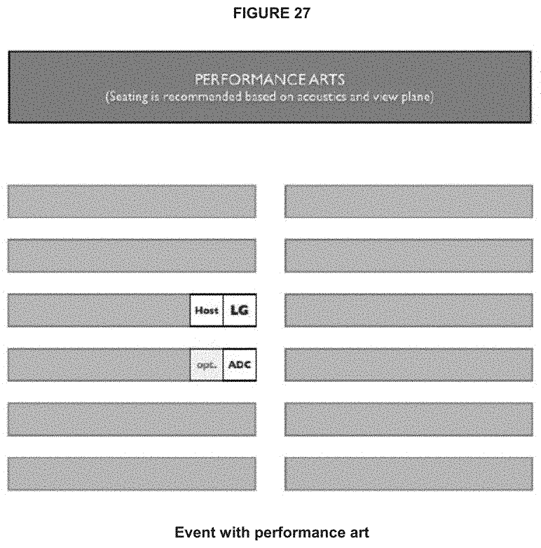

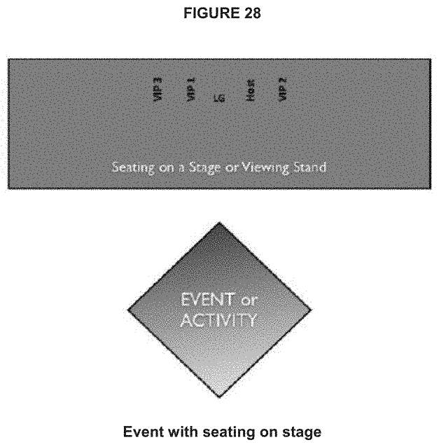

FIGS. 20-28 illustrate example embodiments of seating arrangements for diplomatic events and accompanying seating protocols of various parties, including The Aide de Camp (“ADC”), the Lieutenant Governor (“LG”), the President of the Mess Committee (“PMC”), and multiple VIPs (“very important person”). FIG. 20 illustrates an example seating arrangement of guest tables without a stage. FIG. 21 illustrates an example seating arrangement of guest tables with a stage. FIG. 22 illustrates an example seating arrangement of a banquet table with additional guest tables. FIG. 23 illustrates an example seating arrangement of a banquet table. FIG. 24 illustrates an example seating arrangement at a typical military Mess Dinner. FIG. 25 illustrates an example seating arrangement at a naval Mess Dinner. FIG. 26 illustrates an example seating arrangement at an event not involving acoustics or performance art. FIG. 27 illustrates an example seating arrangement at an event involving acoustics and performance art. FIG. 28 illustrates an example seating arrangement of an event with seating on the stage. It should be appreciated that the preceding example seating arrangements are only selected embodiments for illustration purposes and the seating management system 100 can be used with any custom-created seating arrangement.

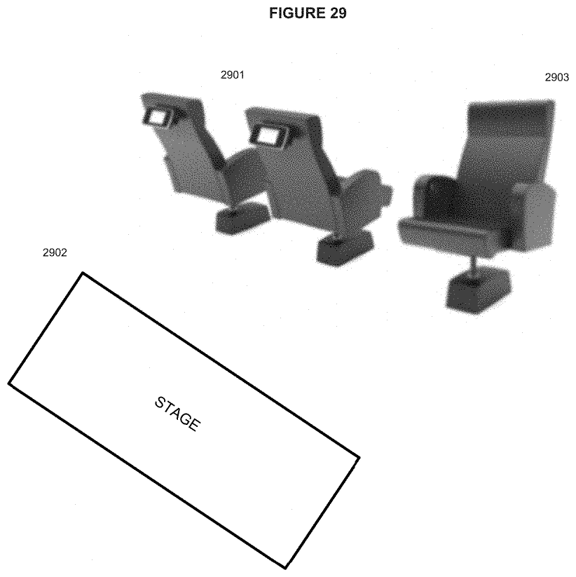

In various embodiments, the chairs in the chosen seating arrangement will be in a closed position, facing away from the event's focus, prior to the start of the event. The chairs will then rotate to face the event's focus when they are opened with a reservation code, as will be discussed in more detail below. The event's focus may be defined as a variety of attractions, for example, a stage, dinner table, boardroom table, sporting event, or other similar attractions. In the preferred embodiment, the chairs will face directly away from the event's focus and rotate 180 degrees when opened to face the event's focus. In other embodiments, the closed position of the chairs may be at different angles relative to the event's focus and as a result the chairs may rotate different degrees when opened. FIG. 29 illustrates an example of the preferred embodiment wherein closed chairs 2901 face directly away from the event stage 2902 and the open chair 2903 is rotated 180 degrees to face the stage 2902. In other various embodiments, the chairs will not rotate, but will move left, right, forward, back, up, or down when they are opened with a reservation code. In such embodiments, the chairs may face in any direction when in the closed position.

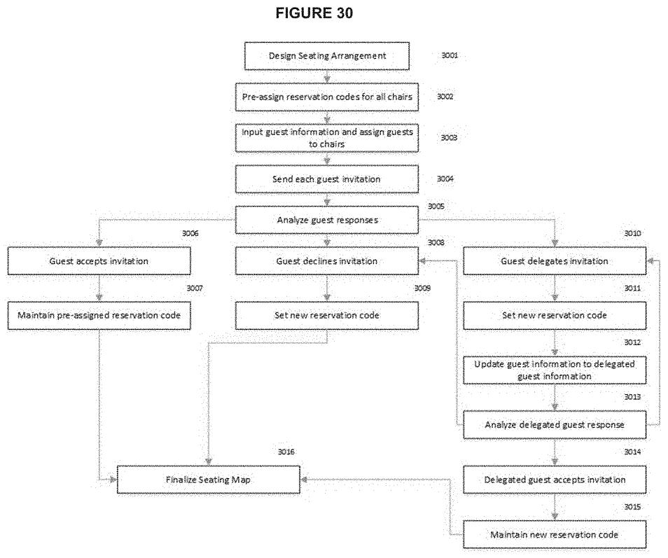

Now referring to FIG. 30, the preferred method of utilizing seating management system 100 begins with designing the seating arrangement chosen by the event holder, designated as step 3001. This step may comprise selecting a generic seating template, such as those in FIGS. 6-28, or designing a custom seating arrangement. The central management server 101 then pre-assigns a reservation code for each of the chairs in the selected seating arrangement in step 3002. The reservation code may, for example, be a QR code. The event organizer then assigns all of the invited guests to a chair and inputs each respective guest's information into the system using the soft application 102 or the web portal 103 in step 3003. Once all the guests are assigned to chairs, the central management server 101 sends an e-mail to each of the invited guests in step 3004. It should be appreciated that throughout this disclosure an e-mail is the preferred form of communication, but the system 101 may use any form of electronic communication.

The invited guests then have the option of accepting or declining the invitation, or delegating the invitation to a different guest. The central management server 101 analyzes the invited guest responses as they are submitted in step 3005. If an invited guest accepts the invitation, designated as step 3006, the system 101 maintains the pre-assigned reservation code for the chair in step 3007 and sends the invited guest a confirmation e-mail of the acceptance. If an invited guest declines or delegates the invitation, steps 3008 or 3010 respectively, the system 101 assigns a new reservation code to the respective chair originally assigned to the invited guest, steps 3009 or 3011 respectively, and sends a confirmation e-mail to the invited guest regarding the rejection or delegation. If the invitation was delegated, the system 101 will also update the guest information assigned to the respective chair to the delegated guest's information in step 3012. The system 101 then analyzes the delegated guest's response in step 3013. If the delegated guest declines the invitation, the system 101 returns to step 3008. If the delegated guest delegates the invitation, the system 101 returns to step 3010. If the delegated guest accepts the invitation, designated as step 3014, the system 101, in step 3015, maintains the new reservation code for the chair set in step 3011 and sends the delegated guest a confirmation e-mail of the acceptance. At a predetermined time, or after all guest responses are analyzed, the system 101 will finalize the seating map and prevent any more invitations from being accepted in step 3016.

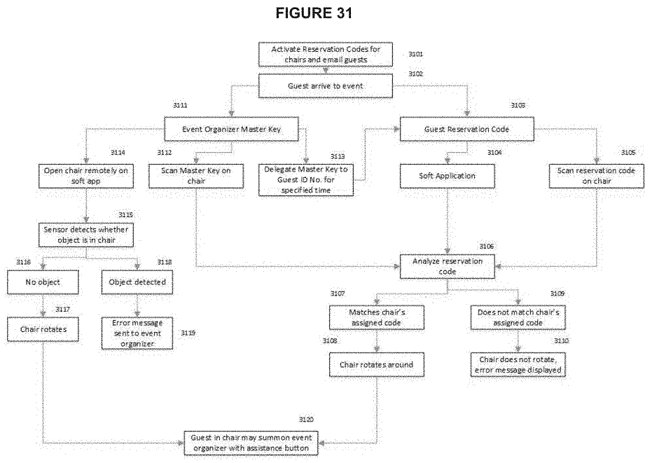

Now referring to FIG. 31, at a predetermined time before the event starts, the central management server 101 will activate the respective reservation codes for all of the chairs and e-mail guests their reservation codes for their respective chairs, which is designated as step 3101. In one embodiment, the codes will be activated 15 minutes before the event starts. After guests arrive to the event at step 3102, they may go to their chairs in the closed position and open them by inputting their respective guest reservation code in step 3103. Guests may do so by either scanning their reservation code on their chair's code scanner 107 in step 3105, or by using the soft application 102 in step 3104. Regardless of the method used, the central management server 101 will analyze the input reservation code in step 3106. In various embodiments, if the input reservation code matches the reservation code assigned to the chair, the system 101 will signal the chair's communication device 105 which will cause the chair's motor 106 to move the chair in steps 3107 and 3108. In the preferred embodiment, and for the duration of this disclosure, the motor rotates the chair, but it should be appreciated that in various other embodiments the motor moves the chair in any direction, such as left, right, forward, backward, up, or down. If the input reservation code does not match the reservation code assigned to the chair, in steps 3109 and 3110 the system 101 will signal the chair's communication device 105 which will cause the chair's display 109 to show an error message, and the chair will not rotate.

Additionally and alternatively, a chair can be opened using an event organizer's master key, designated as step 3111. Such a situation may arise if, for example, an event guest is having technical difficulties, an event organizer needs to change the seating arrangement of guests on the event day, an event organizer is seating an important guest who does not have his or her own reservation code, or other similar situations. An event organizer may scan the master key on a chair's code scanner 107 in step 3112 to open it, which would then repeat steps 3106-3110. Or, the event organizer may delegate the master key to a guest ID number for a specified amount of time in step 3113. The guest may then either scan the master key on his or her chair's code scanner 107 or use the soft application 102. Additionally and alternatively, the event organizer may open a chair remotely using the soft application 102. When an event organizer attempts to open a chair remotely, the chair's object detection sensor 108 detects whether there is an object in the chair in step 3115. If there is no object in the chair, the chair will open and rotate in steps 3116 and 3117. If there is an object in the chair, an error message will be sent to the event organizer in steps 3118 and 3119.

In one embodiment, once a guest has opened a chair and is seated, the guest may request assistance from the event organizer in step 3120 by pressing the service button 110 on his or her chair. The soft application 102 will alert the event organizer which chair has requested assistance. It should be appreciated that said alert may be any kind of alert, such as a message, a light, a sound, a vibration, or any other form of alert. In one embodiment, the service button 110 will shine blue for five seconds to notify the chair's guest that a request has been sent. The alert on the soft application 102 will not go away until the event organizer assists the guest and the service button 110 is pressed again. In various embodiments, the event organizer also uses the soft application 102 to deactivate all of the reservation codes for the plurality of smart chairs and set them back to their closed positions once the event is over. In various embodiments, after the event is over the central management server 101 will cause a performance analysis report to be generated. A performance analysis report may, for example, include information such as event holder information, event information, total attendance, total invitations sent, number of delegations, number of acceptances and rejections, and other statistical information along with recommendations for future events.

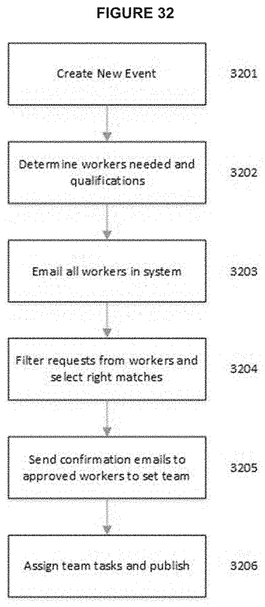

Referring now to FIG. 32, in various embodiments the seating management system 100 is also used by the event organizer to set the management team that will work the event. Said process can be carried out using the user interface of either the soft application 102 or the web portal 103, both of which will operatively communicate with the central management server 101. An event organizer first creates a new event in step 3201, including inputting the event date, time, and location. The event organizer next in step 3202 inputs the required number of workers needed for the event and the necessary qualifications according to various template groups, such as IT, transportation, administration, marketing, media, social media records, public relations, diplomatic relations, logistics workers, and government relations. The event organizer then sends an email to all workers in the system in step 3203. The interested workers submit requests to work the event and the event organizer filters through the workers based on, for example, a worker's number of years of experience and past positions, to select the desired workers in step 3204. The event organizer emails the approved workers to set the event management team in step 3205. Once set, the event organizer assigns the team a list of tasks in step 3206, such as determining the dress code and documents needed, and attending workshops, seminars, or meetings, which the event organizer publishes to the soft application 102 and web portal 103.

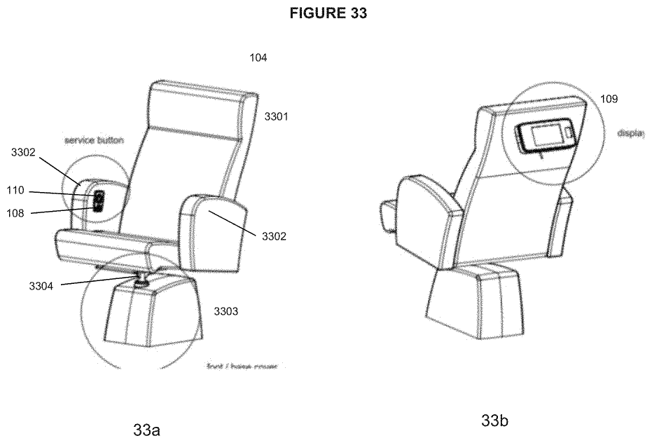

Referring now to FIG. 33, an example embodiment of an individual smart chair 104 is shown. It should be appreciated, however, that a smart chair 104 in system 100 may have any number of designs. FIG. 33a illustrates a front view of the smart chair and FIG. 33b illustrates a rear view. Each chair comprises a headrest 3301, two armrests 3302, a base cover 3303 housing a motor 106 (not shown), a support axis member 3304, a display 109, an object detection sensor 108, and a service button 110. The object detection sensor 108 may be housed in the base of the service button 110 or may be a separate structure. In the preferred embodiment, the sensor 108 is housed in the base of the button 110 and together they are located on the inside of an armrest, though it should be appreciated that in various other embodiments these components are located anywhere on the chair as long as the sensor is able to detect whether an object is in the chair. In the preferred embodiment, the display 109 is attached to the back of the headrest 3301, though it is understood that the display 109 may be attached, connected, placed, joined, or built in anywhere on the chair 104 such that it is visible to a guest facing the chair.

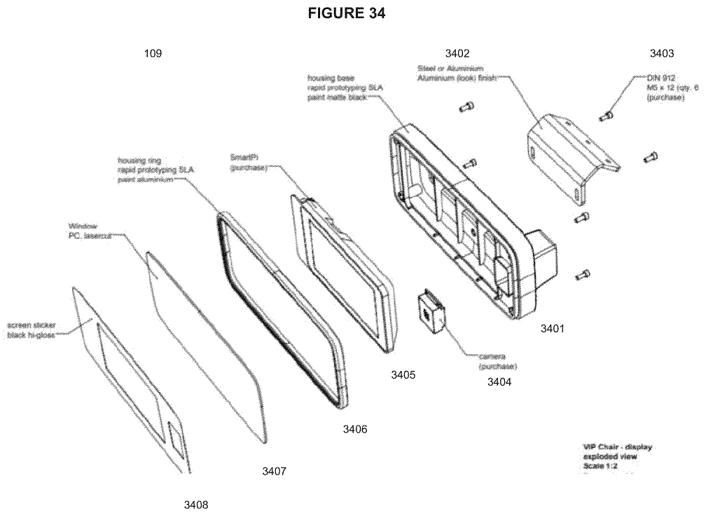

Referring now to FIG. 34, the display 109 may comprise a housing base 3401, a mount 3402, securing means 3403, a camera 3404, a touchscreen 3405, a housing ring 3406, a window 3407, and a screen sticker 3408. The camera 3404 and touchscreen 3405 can be any respective commercial version and are well-known in the art. In one embodiment, the touchscreen 3405 is a SmartPi touchscreen monitor for Raspberry Pi.

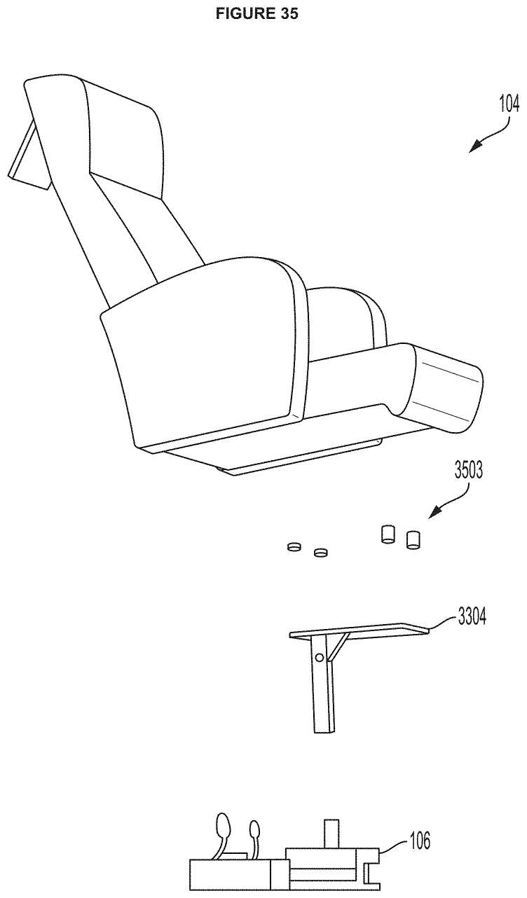

Referring now to FIG. 35, in various embodiments each smart chair 104 is secured with a securing means 3503, such as bolts, to the support axis member 3304 which is then attached to the motor 106. In the preferred embodiment, the motor 106 may be any commercially available motor that is capable of rotating the chair. In certain embodiments, the motor 106 is capable of moving the chair in all directions, such as right, left, forward, back, up, and down. In the preferred embodiment, the central management server 101 is also configured to cause the motor 106 to smoothly rotate the chair to reduce the risk of injury to any guests. For example, the motor 106 may take four seconds to rotate the chair 180 degrees from the closed position to the open position, consisting of 1.5 seconds accelerating from the closed position, 1 second at a target speed, and 1.5 seconds decelerating to the open position. In various embodiments, each chair 104 also comprises a clutch that allows a person to rotate the chair manually should an emergency arise.

In one embodiment, each smart chair 104 is connected to at least one power source to provide energy for its electronic and mechanical components. In another embodiment, each smart chair 104 comprises at least one rechargeable battery to provide energy. In another embodiment, each smart chair 104 is designed for outdoor events and comprises at least one solar panel to generate power for the chair. It should be appreciated that each smart chair 104 needs power to function, but how that power is provided is not meant to be limiting.

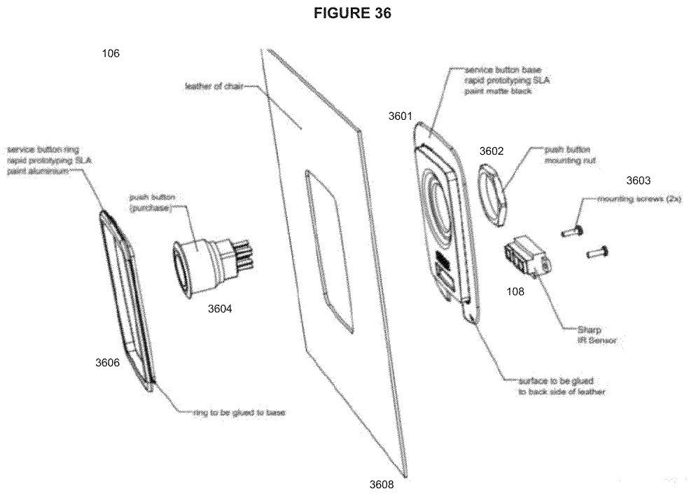

Referring now to FIG. 36, an example embodiment of a service button 110 with a sensor 108 housed in its base is illustrated. The service button 110 comprises a service button base 3601, a mounting nut 3602, securing means 3603, an object detection sensor 108, a push button 3604, and a button ring 3605. The securing means 3603, may, for example, be screws. The service button base 3601 comprises a side, denoted 3607, that is glued to the leather of the chair, denoted 3608. The button ring 3605 comprises a surface, denoted 3606, which is then glued to the service button base 3601 with the leather of the chair in between, as illustrated in FIG. 36. The object detection sensor 108 may be any sensor capable of detecting whether an object is present, such as, for example, an infrared sensor or a pressure sensor.

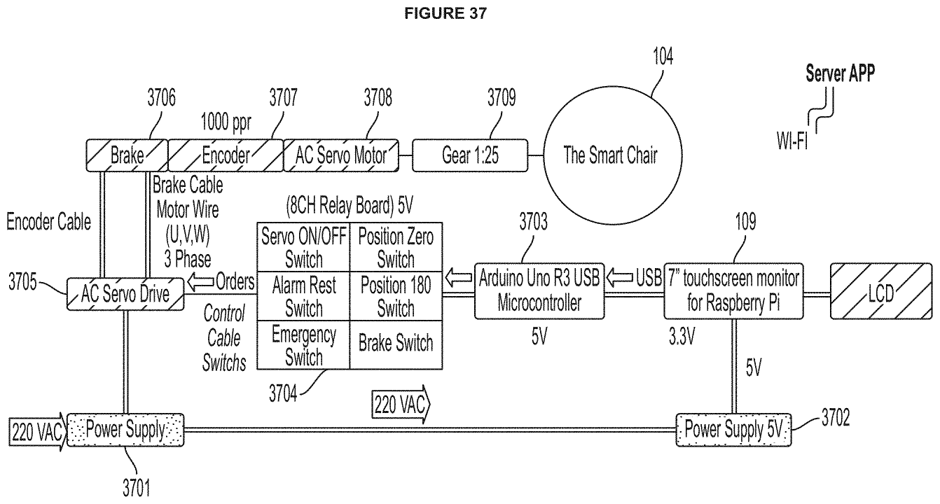

Referring now to FIG. 37, an exemplary power system for the smart chair 104 is illustrated. In one embodiment, a power supply 3701 supplies power to an AC Servo Drive 3705 and a second power supply 3702. The second power supply 3702 supplies power to the display 109 which is further electrically connected to a Microcontroller 3703, which is further connected to a relay board 3704, which is then connected to the AC Servo Drive 3705. In one embodiment, the relay board 3704 comprises a servo on/off switch, an alarm rest switch, an emergency switch, a position zero switch, a position 180 switch, and a brake switch. In one embodiment, the AC Servo Drive 3705 is connected to a brake 3706, an encoder 3707, an AC Servo Motor 3708, and a gear 1:25 3709, which all work to rotate the smart chair 104.

Without further elaboration, it is believed that one skilled in the art can use the preceding description to utilize the claimed inventions to their fullest extent. The examples and embodiments disclosed herein are to be construed as merely illustrative and not a limitation of the scope of the present disclosure in any way. It will be apparent to those having skill in the art that changes may be made to the details of the above-described embodiments without departing from the underlying principles discussed. In other words, various modifications and improvements of the embodiments specifically disclosed in the description above are within the scope of the appended claims. For example, any suitable combination of features of the various embodiments described is contemplated. Note that elements recited in means-plus-function format are intended to be construed in accordance with 35 U.S.C. § 112 ¶ if 6. The scope of the invention is therefore defined by the following claims.

1. A seating management system, comprising:
a plurality of chairs each comprising:
a code scanner;
an object detection sensor;
a motor; and
a communication device in operative communication with a central management server; and wherein the central management server is configured to:
pre-assign a reservation code for each of the plurality of chairs;
assign each of at least one of a plurality of invited guests to a respective one of the plurality of chairs;
cause an invitation to be sent to each of said invited guests;
analyze a plurality of invited guest responses to said invitations;
if one of the plurality of invited guests declines the event or delegates the invitation to a different guest, set a new reservation code for the respective chair originally assigned to the invited guest;
if one of the plurality of invited guests accepts the invitation, maintain the reservation code of the chair originally assigned to the invited guest;
activate the plurality of chairs;
send the respective pre-assigned reservation code or new reservation code to each of the plurality of invited or different guests whose responses accepted the invitation, said pre-assigned reservation code or new reservation code corresponding to the chair each invited or different guest is assigned to; and
cause the motor of the respective activated chair to move said chair when the central management server receives a pre-assigned reservation code or new reservation code corresponding to said chair.

2. The system of claim 1, wherein the central management server is further configured to generate a performance analysis report.

3. The system of claim 1, wherein the reservation codes are pre-assigned to each of the plurality of chairs on the basis of a designated seating template.

4. The system of claim 1, wherein the central management server causes the motor to rotate the chair to a predesignated viewing position for the event.

5. The system of claim 4, wherein the motor will not rotate the chair if an object detection sensor detects an object in the chair.

6. The system of claim 4, wherein the object detection sensor is an infrared sensor.

7. The system of claim 1, wherein the reservation code is a QR code.

8. A method for managing event seating arrangements, comprising:
receiving an input selecting from a plurality of seating arrangements, wherein each seating arrangement comprises a plurality of chairs and each of the plurality of chairs in each seating arrangement has a pre-assigned reservation code;
receiving a plurality of inputs assigning a plurality of invited guests to the plurality of chairs in the selected seating arrangement;
sending a plurality of invitations to the plurality of invited guests assigned to the plurality of chairs;
receiving a plurality of responses to said invitations from said plurality of invited guests assigned to said plurality of chairs;
setting a new reservation code for a chair assigned to an invited guest if the response from the invited guest declines or delegates the invitation;
updating the information of an invited guest assigned to a chair to the information of a delegated guest if the invited guest delegates the invitation to the delegated guest;
activating each of the plurality of chairs;
sending a pre-assigned reservation code or new reservation code to each invited guest or delegated guest whose response accepts the invitation, said pre-assigned reservation code or new reservation code corresponding to the chair each invited guest or delegated guest is assigned to; and
sending a signal to a motor to move a chair if a central management server receives a pre-assigned or new reservation code corresponding to said chair.

9. The method of claim 8, wherein the method further comprises generating a performance analysis report.

10. The method of claim 8, wherein the method further comprises receiving a request from a guest and alerting an organizer.

11. The method of claim 8, wherein the reservation code is a QR code, a mobile application signal, or a master key signal.

12. The method of claim 8, wherein the motor rotates the chair to a predesignated viewing position for the event.

13. The method of claim 12, wherein the motor will not rotate the chair if an object detection sensor detects that an object is in the chair, said object detection sensor being attached or built into the chair.

14. The method of claim 12, wherein the object detection sensor is an infrared sensor.

15. A smart chair capable of communicating with a network, comprising:
a smart display, wherein the smart display is attached or built into the back of the chair;
a code scanner;
a communication device, wherein the communication device is in operative communication with a central management server;
an object detection sensor, wherein the object detection sensor is configured to detect whether an object is in the chair; and
a motor, wherein the motor is configured to move the chair.

16. The chair of claim 15, wherein the motor is configured to rotate the chair to a predesignated viewing position for the event.

17. The chair of claim 16, wherein the motor will not rotate the chair if the object detection sensor detects an object in the chair.

18. The chair of claim 15, wherein the object detection sensor is an infrared sensor.

19. The chair of claim 15, wherein the code scanner is configured to recognize QR codes.

20. The chair of claim 15, wherein the chair further comprises a service button for requesting assistance.
